(19) United States
(12) Patent Application Publication
(10) Pub. No.: US 2026/0097538 A1
(43) Pub. Date: Apr. 9, 2026

(54) ELECTRIC HEATING KNIFE WITH A BRACKET

(71) Applicant: CHANGZHOU CANTY ELECTRIC INDUSTRY CO., LTD, Changzhou (CN)

(72) Inventors: Jiazhong CHENG, Changzhou (CN); Jianwei SHAO, Changzhou (CN)

(21) Appl. No.: 19/194,610

(22) Filed: Apr. 30, 2025

(30) Foreign Application Priority Data
Oct. 8, 2024 (CN) 202422430700.6

(51) Int. Cl. B26F 3/12

(52) U.S. Cl. CPC B26F 3/12

(57) ABSTRACT

The electric heating knife with a bracket includes a handle. The bracket is provided with a first rotating shaft, a second rotating shaft, and a supporting frame connected there between. The first rotating shaft and the second rotating shaft are rotatably connected to two sidewalls of the handle, respectively. The rotation angle of the supporting frame is limited by the first limiting portion and the second limiting portion, and the rotation axis of the first rotating shaft and the rotation axis of the second rotating shaft coincide and are both parallel to the first direction. When the supporting frame is engaged with the first limiting portion, the supporting frame and the hand-held portion support the electric knife jointly and allow the blade to be suspended, and when the supporting frame is engaged with the second limiting portion, at least a part of the supporting frame is accommodated in the connecting portion.

### CROSS-REFERENCE TO RELATED APPLICATION

This application claims priority to and the benefit of Chinese Patent Application No. 202422430700.6, filed on Oct. 8, 2024, the disclosure of which is incorporated herein by reference in its entirety.

### TECHNICAL FIELD

The present disclosure relates to the field of electric heating knife, and in particular, to an electric heating knife with a bracket.

### BACKGROUND

Electric heating knife refers to the hand-held cutter that uses electric energy to generate heat to achieve cutting, and it is divided into two types. In one type, an electric heating wire is installed in the knife, and the electric heating wire generates heat after being energized. This type of electric heating knife has advantages of low price, low cost and simple structure. In the other type, the resistance of a blade is utilized, and the heating of the hand-held electric heating knife can be realized through high current. The preheating time of this type of electric heating knife is very short, and the blade can reach a hot state in only a few seconds, resulting in a high efficiency. Electric heating knife can be used to cut foam plastic, foam adhesive, plastic, rubber, insulating paper, insulating cloth, cloth, leather, fabric and the like.

In the case of continuous cutting operation, when the staff needs to adjust the cutting position of the cutting item, the electric heating knife needs to be temporarily placed on the placement table. On the one hand, it is inconvenient for the staff to pick and place, and the blade end of the electric heating knife may be taken by mistake, resulting in burns. On the other hand, if the hot blade after heating is placed on the placement table, other items placed on the placement table may be burned.

### SUMMARY

The present disclosure provides an electric heating knife with a bracket, which can solve the problem of low safety when the electric heating knife is placed on the placement table.

In order to achieve the above object, embodiments of the present disclosure provide an electric heating knife with a bracket including a handle, the handle includes a connecting portion and a hand-held portion, the connecting portion is connected with a knife holder, the knife holder is connected with a blade, the connecting portion is provided with two sidewalls disposed opposite to each other in a first direction, each of the two sidewalls is provided with a first limiting portion and a second limiting portion, the first limiting portion is closer to the knife holder relative to the second limiting portion, the electric heating knife further includes a bracket, the bracket is provided with a first rotating shaft, a second rotating shaft, and a supporting frame connected between the first rotating shaft and the second rotating shaft, the first rotating shaft and the second rotating shaft are rotatably connected to the two sidewalls, respectively, a rotation angle of the supporting frame is jointly limited by the first limiting portion and the second limiting portion, and a rotation axis of the first rotating shaft and a rotation axis of the second rotating shaft coincide and are both parallel to the first direction;
when the supporting frame is engaged with the first limiting portion, the supporting frame and an end of the hand-held portion facing away from the connecting portion are both in contact with a placement table to support the electric heating knife and allow the blade to be suspended; when the supporting frame is engaged with the second limiting portion, at least a part of the supporting frame is accommodated in the connecting portion.

In some embodiments of the present disclosure, two mating holes extending along the first direction are provided on the two sidewalls, respectively, the first rotating shaft and the second rotating shaft are rotatably fitted in a corresponding one of the mating holes, respectively, and the supporting frame provides the first rotating shaft and the second rotating shaft with a force causing the first rotating shaft and the second rotating shaft to approach each other.

In some embodiments of the present disclosure, the supporting frame includes a first connecting segment, a second connecting segment, two supporting portions arranged at an interval along the first direction, and a connecting structure connected between the two supporting portions, one of the two supporting portions is fixedly connected to the first rotating shaft through the first connecting segment, another one of the two supporting portions is fixedly connected to the second rotating shaft through the second connecting segment, each of the first connecting segment and the second connecting segment is provided with a tapered sub-segment, a distance between the tapered sub-segment of the first connecting segment and the tapered sub-segments of the second connecting segment in the first direction gradually decreases along a direction away from the two supporting portions, and both the first connecting segment and the second connecting segment have elasticity.

In some embodiments of the present disclosure, the supporting frame includes two supporting portions arranged at an interval along the first direction, the electric heating knife is provided with a hypothetical reference plane, the reference plane is perpendicular to the placement table and parallel to an extending direction of the blade, when the supporting frame is engaged with the first limiting portion, the rotation axis of the first rotating shaft has a first projection point on the reference plane, each of the two supporting portions has a second projection point on the reference plane, and an angle α is provided between a line connecting the first projection point with the second projection point and the extending direction of the blade, the angle α satisfies: 30°˜90°.

In some embodiments of the present disclosure, the first limiting portion includes a first limiting plate protruding from one of the two sidewalls, and the second limiting portion includes a second limiting plate protruding from another one of the two sidewalls, an extending direction of the first limiting plate intersects with an extending direction of the second limiting plate at an intersecting point, and the intersecting point coincides with the rotation axis of the first rotating shaft.

In some embodiments of the present disclosure, the supporting frame includes a first connecting segment, a second connecting segment, two supporting portions arranged at an interval along the first direction, and a connecting structure connected between the two supporting portions, a stop platform is further provided on each of the two sidewalls in a protruding manner, when the first connecting segment and the second connecting segment respectively abut against the first limiting plate corresponding thereto, the stop platform and the first limiting plate are respectively located at two sides of the supporting frame, and a dimension of the stop platform in the first direction is less than a dimension of the first connecting segment in the first direction and is less than a dimension of the second connecting segment in the first direction.

In some embodiments of the present disclosure, the hand-held portion is provided with an adapting end and a supporting end, the adapting end is provided with two connecting arms that are opposite and disposed at an interval in the first direction, an end of the connecting portion facing away from the knife holder is disposed in the interval and is rotatably connected to the two connecting arms, and a rotation axis of the connecting portion is parallel to the first direction.

In some embodiments of the present disclosure, the supporting frame includes a first connecting segment, a second connecting segment, two supporting portions arranged at an interval along the first direction, and a connecting structure connected between the two supporting portions, one of the two supporting portions is fixedly connected to the first rotating shaft through the first connecting segment, another one of the two supporting portions is fixedly connected to the second rotating shaft through the second connecting segment, each of the first connecting segment and the second connecting segment is provided with a supporting sub-segment, a distance between the supporting sub-segment of the first connecting segment and the supporting sub-segment of the second connecting segment are equal in the first direction, the two connecting arms are provided with two supporting outer wall surfaces disposed facing away from each other, the two supporting sub-segments are provided with two outer supporting surfaces disposed facing away from each other, and a plane where one of the two outer supporting surfaces is located coincides with a plane where one of the two supporting outer wall surfaces is located.

In some embodiments of the present disclosure, the supporting frame includes two supporting portions facing away from the first rotating shaft and arranged at an interval in the first direction, the two supporting portions have a first dimension L1 in the first direction, a maximum dimension of the handle 1 in the first direction is L2, and L1=(0.9˜1.5)×L2.

In some embodiments of the present disclosure, the hand-held portion is provided with an adapting end and a supporting end, and the supporting end is provided with a hanging and connecting portion.

The above technical solutions of the present disclosure have at least the following beneficial effects: when the staff needs to adjust the cutting position of the cutting item, the bracket can be rotated until the supporting frame of the bracket is engaged with and limited by the first limiting portion. In this case, the bracket cannot continue to rotate, the supporting frame and the end of the hand-held portion facing away from the connecting portion are in contact with the placement table, so as to jointly support the electric heating knife and allow the blade to be suspended above the placement table. In this case, the blade faces downward, and the handle 1 is generally placed close to the staff, making it easy for the staff to grip the handle the next time they take it, which is beneficial in avoiding burns to the staff. On the other hand, the blade suspended in the air can further avoid scorch of other items placed on the placement table.

### BRIEF DESCRIPTION OF THE DRAWINGS

In order to illustrate the technical solutions in the embodiments of the present disclosure more clearly, the drawings used in the description of the embodiments will be introduced briefly below. It is apparent that the drawings in the following description are merely some of embodiments of the present disclosure, and other drawings may be obtained by those skilled in the art without making creative efforts.

FIG. 1 is a perspective view of an electric heating knife with a bracket according to some embodiments of the present disclosure;

FIG. 2 is a perspective view of a bracket in an electric heating knife with a bracket according to some embodiments of the present disclosure;

FIG. 3 is a front view of an electric heating knife with a bracket when it is placed on a placement table according to some embodiments of the present disclosure;

FIG. 4 is an enlarged view of part A in FIG. 3;

FIG. 5 is a perspective view of another electric heating knife with a bracket according to some embodiments of the present disclosure;

FIG. 6 is an enlarged view of part B in FIG. 5;

FIG. 7 is a front view of another electric heating knife with a bracket of which a blade is folded and when it is placed in a sideway according to some embodiments of the present disclosure;

FIG. 8 is a perspective view of yet another electric heating knife with a bracket according to some embodiments of the present disclosure;

FIG. 9 is a top view of yet another electric heating knife with a bracket according to some embodiments of the present disclosure.

The reference numerals in the drawings of the present disclosure are listed below:
1—Handle; 11—Connecting portion; 111—Sidewall; 1111—First limiting plate; 1112—Second limiting plate; 1113—Stop platform; 12—Hand-held portion; 121—Connecting arm;
2—Knife holder;
3—Blade;
4—Bracket; 41—First rotating shaft; 42—Second rotating shaft; 43—Supporting frame; 431—First connecting segment; 4311—First tapered sub-segment; 4312—First supporting sub-segment; 432—Second connecting segment; 4321—Second tapered sub-segment; 4322—Second supporting sub-segment; 433—Supporting portion; 434—Connecting structure;
5—hanging and Connecting Portion;
100—Placement table;
X—First direction.

### DETAILED DESCRIPTION

Technical solutions in embodiments of the present disclosure will be described clearly and completely below in conjunction with the accompanying drawings in the embodiments of the present disclosure, and it is apparent that described embodiments are only a part of the embodiments but not all of the embodiments of the present disclosure. Based on the embodiments of the present disclosure, all other embodiments obtained by those skilled in the art without making creative efforts fall within the scope of protection of the present disclosure.

In the description of the disclosure, it should be understood that directional or positional relationships indicated by the terms “center”, “upper”, “lower”, “front”, “back”, “left”, “right”, “vertical”, “horizontal”, “top”, “bottom”, “inside”, “outside”, and the like, as shown in the drawings, are only for the convenience of describing the present disclosure and simplifying the description, rather than indicating or implying that the device or element referred to must have a specific orientation, or be constructed and operated in a specific orientation. Therefore, the terms should not be interpreted as limitations of the present disclosure.

The terms “first” and “second” are only used for descriptive purposes, and cannot be interpreted as indicating or implying the relative importance or implicitly indicating the quantity of the technical features. Therefore, the features defined as the “first” and “second” may explicitly or implicitly include one or more features. In the description of the present disclosure, “a plurality of” means two or more than two, unless otherwise clearly and specifically limited.

In the description of the present disclosure, it should be understood that unless otherwise explicitly specified and limited, the terms “installed”, “connected” and “coupled” should be understood in a broad sense. For example, it can be a fixed connection, a detachable connection, or integrally connected. It can be a mechanical connection, a direct connection or an indirect connection through an intermediary, and it can also be an inner communication between two elements. For those skilled in the art, the specific meanings of these terms in the present disclosure can be understood based on the specific circumstances.

The present disclosure provides an electric heating knife, the structure of which is described in detail below. It should be noted that the description order of the following embodiments is not intended to limit the preferred order of the embodiments in the present disclosure. In the embodiments below, each embodiment is described with its own emphasis. For parts that are not described in detail in a certain embodiment, reference can be made to the relevant descriptions of other embodiments.

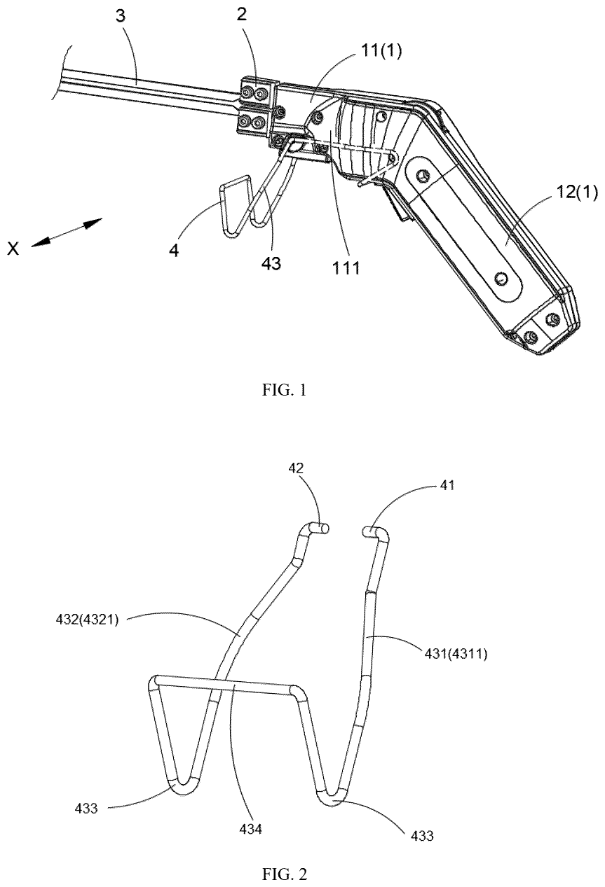

Referring to FIG. 1 and FIG. 2, the electric heating knife with a bracket provided by the present disclosure includes a handle 1, the handle 1 includes a connecting portion 11 and a hand-held portion 12. The connecting portion 11 is connected with a knife holder 2, and the knife holder 2 is connected with a blade 3. The connecting portion 11 is provided with two sidewalls 111 disposed opposite to each other in a first direction X, each of the two sidewalls 111 is provided with a first limiting portion and a second limiting portion, and the first limiting portion is closer to the knife holder 2 relative to the second limiting portion. The electric heating knife further includes a bracket 4, the bracket 4 is provided with a first rotating shaft 41, a second rotating shaft 42, and a supporting frame 43 connected between the first rotating shaft 41 and the second rotating shaft 42. The first rotating shaft 41 and the second rotating shaft 42 are rotatably connected to the two sidewalls 111, respectively. The rotation angle of the supporting frame 43 is limited by the first limiting portion and the second limiting portions jointly, and the rotation axis of the first rotating shaft 41 and the rotation axis of the second rotating shaft 42 coincide and are both parallel to the first direction X. When the supporting frame 43 is engaged with the first limiting portion, the supporting frame 43 and the end of the hand-held portion 12 facing away from the connecting portion 11 are in contact with the placement table 100, so as to jointly support the electric heating knife and allow the blade 3 to be suspended above the placement table 100. When the supporting frame 43 is engaged with the second limiting portion, at least a part of the supporting frame 43 is accommodated in the connecting portion 11.

In this technical solution, when the staff needs to adjust the cutting position of the cutting item, the bracket 4 can be rotated until the supporting frame 43 of the bracket 4 is engaged with and limited by the first limiting portion. In this case, the bracket 4 cannot continue to rotate, the supporting frame 43 and the end of the hand-held portion 12 facing away from the connecting portion 11 are in contact with the placement table 100, so as to jointly support the electric heating knife and allow the blade 3 to be suspended above the placement table 111. In this case, the blade faces downward, and the handle 1 is generally placed close to the staff, making it easy for the staff to grip the handle 1 the next time they take it, which is beneficial in avoiding burns to the staff. On the other hand, the blade suspended in the air can further avoid scorch of other items placed on the placement table 100.

Further, when the supporting frame 43 is engaged with the second limiting portion, at least a part of the supporting frame 43 is accommodated in the connecting portion 11 to prevent the bracket 4 from affecting the cutting operation of the electric heating knife. Moreover, compared to the embodiment in which the bracket is placed independently on the placement table 100 and then the electric heating knife is placed on the bracket after use, in the present disclosure, the bracket 4 is rotatably connected to the sidewall 111. In this case, when placing the electric heating knife, there is no need to align the electric heating knife with the bracket 4 before placing, making usage more convenient.

A mating hole extending in the first direction is disposed on each of the two sidewalls 111, and the first rotating shaft 41 and the second rotating shaft 42 are rotatably fitted in the corresponding mating hole, respectively. The supporting frame 43 can provide the first rotating shaft 41 and the second rotating shaft 42 with a force causing them to approach each other, so as to prevent the first rotating shaft 41 and the second rotating shaft 42 from coming out of the corresponding mating hole, and prevent the first rotating shaft 41 and the second rotating shaft 42 from being loosened or swayed during rotation, thereby improving the stability of the bracket 4.

In some embodiments, the supporting frame 43 includes a first connecting segment 431, a second connecting segment 432, two supporting portions 433 arranged at an interval along the first direction X, and a connecting structure 434 connected between the two supporting portions 433. The connecting structure 434 can connect the partial structures of the bracket 4 that are respectively engaged on the two sidewalls 111 together to achieve modularity of the bracket 4. One supporting portion 433 is fixedly connected to the first rotating shaft 41 through the first connecting segment 431, and the other supporting portion 433 is fixedly connected to the second rotating shaft 42 through the second connecting segment 432. Each of the first connecting segment 431 and the second connecting segment 432 has a tapered sub-segment (for example, the first tapered sub-segment 4311 and the second tapered sub-segment 4321), and the distance between the two tapered sub-segments in the first direction X gradually decreases along the direction away from the supporting portion 433, and both the first connecting segment 431 and the second connecting segment 432 have elasticity. Accordingly, the first rotating shaft 41 and the second rotating shaft 42 are provided with a force causing them to approach each other by the convergent tendency between the first connecting segment 431 and the second connecting segment 432, and the first connecting segment 431 and the second connecting segment 432 have elasticity. Therefore, during installation, the first connecting segment 431 and the second connecting segment 432 can be manually pulled to make the first rotating shaft 41 and the second rotating shaft 42 away from each other, so as to facilitate the assembly between the first rotating shaft 41, the second rotating shaft 42 and the corresponding mating hole.

In some other embodiments, the supporting frame 43 includes a first connecting segment 431, a second connecting segment 432, two supporting portions 433 arranged at an interval along the first direction X, and a connecting structure 434 connected between the two supporting portions 433. One supporting portion 433 is fixedly connected to the first rotating shaft 41 through the first connecting segment 431, and the other supporting portion 433 is fixedly connected to the second rotating shaft 42 through the second connecting segment 432. Furthermore, the supporting frame 43 further includes a spring connected between the first connecting segment 431 and the second connecting segment 432, and the spring is in a stretched state, so that the contraction force of the spring is the force for the first rotating shaft 41 and the second rotating shaft 42 to approach each other.

Based on any one of the above embodiments, the bracket 4 is made by bending a metal wire to obtain the shape or structure described above. For example, the metal wire can be a steel wire or an iron wire. The bracket 4 has an integral structure.

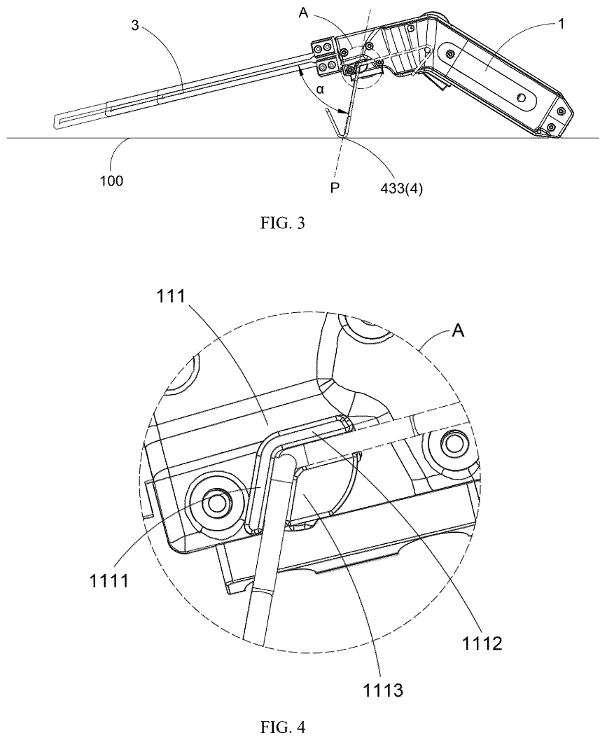

As shown in FIG. 2 and FIG. 3, in order to ensure the support stability of the bracket 4, the supporting frame 43 includes two supporting portions 433 arranged at an interval along the first direction X, and the two supporting portions 433 are both disposed being opposed to the first rotating shaft 41 and the second rotating shaft 42. The electric heating knife is provided with a hypothetical reference plane, which is perpendicular to the placement table 100 and parallel to the extending direction of the blade 3. When the supporting frame 43 is engaged with the first limiting portion, the rotation axis of the first rotating shaft 41 has a first projection point on the reference plane, and the supporting portion 433 has a second projection point on the reference plane. The line P connecting the first projection point and the second projection point forms an angle α with the extending direction of the blade 3, and the angle α satisfies: 30°˜90°.

Referring to FIG. 2 to FIG. 4, the first limiting portion includes a first limiting plate 1111 protruding from the sidewall 111, and the second limiting portion includes a second limiting plate 1112 protruding from the sidewall 111, and the extending direction of the first limiting plate 1111 and the extending direction of the second limiting plate 1112 intersect at an intersecting point, and the intersecting point coincides with the rotation axis of the first rotating shaft 41, so that the structure of the limiting structure is simple and easy to implement.

Alternatively, in some other embodiments, an arc-shaped guiding groove centered on the rotation axis of the first rotating shaft 41 is provided on the sidewall 111, and the guiding groove is provided with a first terminating end and a second terminating end opposite to each other. The first terminating end is closer to the blade relative to the second terminating end, the first terminating end is used to form the first limiting portion, the second terminating end is used to form the second limiting portion, and this solution can be realized by only opening an arc-shaped guiding groove on the sidewall of the connecting portion 11.

Exemplarily, the supporting frame 43 includes a first connecting segment 431, a second connecting segment 432, two supporting portions 433 arranged at an interval along the first direction X, and a connecting structure 434 connected between the two supporting portions 433. A stop platform 1113 is further provided on the sidewall 111 in a protruding manner. When the first connecting segment 431 and the second connecting segment 432 respectively abut against the corresponding first limiting plate 1111, the stop platform 1113 and the first limiting plate 1111 are respectively located at two sides of the supporting frame 43. The dimension of the stop platform 1113 in the first direction X is less than the dimension of the first connecting segment 431 in the first direction X, and is less than the dimension of the second connecting segment 432 in the first direction X, thereby facilitating the rotation of the supporting frame 43. In other words, each of the two sidewalls 111 is provided with a stop platform 1113 in a protruding manner. The dimension of the stop platform 1113 on one sidewall 111 in the first direction X is less than the dimension of the first connecting segment 431 in the first direction X, and the dimension of the stop platform 1113 on the other sidewall 111 in the first direction X is less than the dimension of the second connecting segment 432 in the first direction X. Accordingly, by making the height of the stop platform 1113 lower than the heights of the first connecting segment 431 and the second connecting segment 432, it is ensured that the stop platform 1113 has a limiting function, while facilitating the rotation of the supporting frame 43.

Specifically, the stop platform 1113 and the first limiting plate 1111 are arranged at an interval, and the interval there between constitutes a first limiting groove. The stop platform 1113 and the second limiting plate 1112 are arranged at an interval, and the interval there between constitutes a second limiting groove. The extending direction of the first edge of the stop platform 1113 facing the first limiting plate 1111 is consistent with the extending direction of the first limiting plate 1111, and the extending direction of the second edge of the stop platform 1113 facing the second limiting plate 1112 is consistent with the extending direction of the second limiting plate 1112.

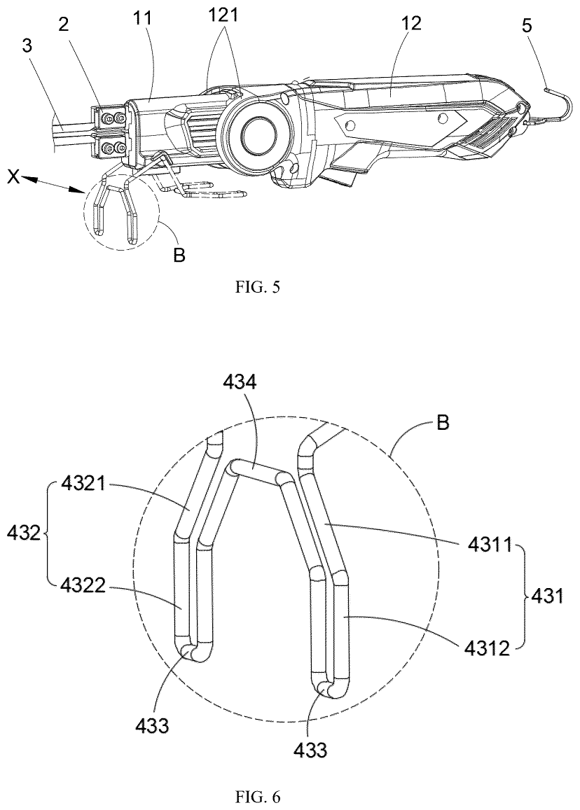

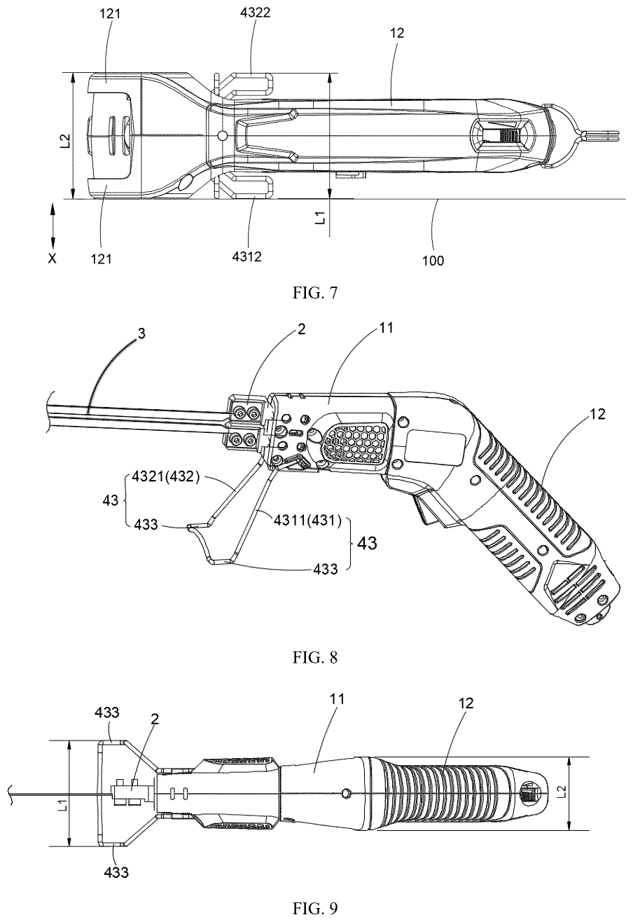

Referring to FIG. 5 to FIG. 7, the hand-held portion 12 is provided with an adapting end and a supporting end. The adapting end is provided with two connecting arms 121 that are opposite to each other and disposed at an interval in the first direction X. The end of the connecting portion 11 facing away from the knife holder 2 is disposed in the interval and is rotatably connected to the two connecting arms 121, and the rotation axis of the connecting portion 11 is parallel to the first direction X, thereby realizing the angle adjustment between the blade 3 and the handle 1 to meet various usage requirements. Under normal circumstances, the extending direction of the connecting portion 11 is the same as the extending direction of the blade 3.

Based on the above embodiments, the supporting frame 43 includes the first connecting segment 431, the second connecting segment 432, two supporting portions 433 arranged at an interval along the first direction X, and the connecting structure 434 connected between the two supporting portions 433. One supporting portion 433 is fixedly connected to the first rotating shaft through the first connecting segment 431, and the other supporting portion 433 is fixedly connected to the second rotating shaft through the second connecting segment 432. Each of the first connecting segment 431 and the second connecting segment 432 is provided with a supporting sub-segment (the first supporting sub-segment 4312 and second supporting sub-segment 4322), and the distance between the two supporting sub-segments in the first direction X is equal everywhere. The two connecting arms 121 are provided with two supporting outer wall surfaces that are disposed facing away from each other, the two supporting sub-segments are provided with two outer supporting surfaces that are disposed facing away from each other, and a plane wherein one of the outer supporting surfaces is located coincides with a plane wherein one of the supporting outer wall surfaces is located, so that the electric heating knife can be supported jointly by the outer supporting surfaces and the supporting outer wall surfaces when the electric heating knife is placed on its side.

Exemplarily, each of the first connecting segment 431 and the second connecting segment 432 has a tapered sub-segment (for example, the first tapered sub-segment 4311 and the second tapered sub-segment 4321), and the distance between the two tapered sub-segments in the first direction X gradually decreases along the direction away from the supporting portion 433 to provide the first rotating shaft and the second rotating shaft with a force allowing them to approach each other.

The supporting frame 43 includes two supporting portions 433 facing away from the first rotating shaft 41 and arranged at an interval in the first direction X. The two supporting portions 433 have a first dimension L1 in the first direction X, and the maximum dimension of the handle 1 in the first direction is L2, L1=(0.9˜1.5)×L2. The first dimension L1 is the maximum dimension of the two supporting portions 433 in the first direction X, which can also be understood as the maximum dimension of the bracket 4 in the first direction X. Exemplarily, in this embodiment, the maximum dimension L2 of the handle 1 in the first direction is the distance between two supporting outer wall surfaces disposed facing away from each other of the two connecting arms 121, and L1=L2.

In addition, referring to FIG. 8 and FIG. 9, the supporting frame 43 includes two supporting portions 433 facing away from the first rotating shaft and arranged at an interval in the first direction X. The two supporting portions 433 have a first dimension L1 in the first direction X, and the maximum dimension of the handle 1 in the first direction is L2, L1=1.4×L2. It is apparent that in some other embodiments not shown in the drawings of the present disclosure, L1=0.9×L2, L1=1.1×L2, L1=1.2×L2, L1=1.3×L2, L1=1.45×L2, and L1=1.5×L2.

In some embodiments of the present disclosure, as shown in FIG. 5, the hand-held portion 12 is provided with an adapting end and a supporting end. The end of the connecting portion 11 facing away from the knife holder 2 is rotatably connected to the adapting end, and the supporting end is provided with a hanging and connecting portion 5, so that the electric heating knife can be hung at a fixed position after use. For example, the hanging and connecting portion is a hook, a hanging hole, or a hanging ring.

In the description of the specification, specific characteristics, structures, materials, or features may be combined in a suitable manner in any one or more embodiments or examples.

The described above is merely specific embodiments of the present disclosure, but the scope of protection of the present disclosure is not limited thereto. Any modifications or replacements that can be easily conceived by those skilled in the art within the scope of the technology disclosed in the present disclosure shall be covered within the scope of protection of the present disclosure. Therefore, the scope of protection of the present disclosure shall be subject to the scope defined by the claims. In addition, specific examples are used in the present disclosure to illustrate the principles and implementation methods of the present disclosure. The description of the above embodiments is only used to help understand the methods and core ideas of the present disclosure, and should be not construed as limiting the present disclosure.

What is claimed is:

1. An electric heating knife with a bracket comprising a handle, wherein the handle comprises a connecting portion and a hand-held portion, the connecting portion is connected with a knife holder, the knife holder is connected with a blade, the connecting portion is provided with two sidewalls disposed opposite to each other in a first direction, each of the two sidewalls is provided with a first limiting portion and a second limiting portion, the first limiting portion is closer to the knife holder relative to the second limiting portion, wherein the electric heating knife further comprises a bracket, the bracket is provided with a first rotating shaft, a second rotating shaft, and a supporting frame connected between the first rotating shaft and the second rotating shaft, the first rotating shaft and the second rotating shaft are rotatably connected to the two sidewalls, respectively, a rotation angle of the supporting frame is jointly limited by the first limiting portion and the second limiting portion, and a rotation axis of the first rotating shaft and a rotation axis of the second rotating shaft coincide and are both parallel to the first direction;
wherein when the supporting frame is engaged with the first limiting portion, the supporting frame and an end of the hand-held portion facing away from the connecting portion are both in contact with a placement table to support the electric heating knife and allow the blade to be suspended; when the supporting frame is engaged with the second limiting portion, at least a part of the supporting frame is accommodated in the connecting portion.

2. The electric heating knife with a bracket according to claim 1, wherein two mating holes extending along the first direction are provided on the two sidewalls, respectively, the first rotating shaft and the second rotating shaft are rotatably fitted in a corresponding one of the mating holes, respectively, and the supporting frame provides the first rotating shaft and the second rotating shaft with a force causing the first rotating shaft and the second rotating shaft to approach each other.

3. The electric heating knife with a bracket according to claim 2, wherein the supporting frame comprises a first connecting segment, a second connecting segment, two supporting portions arranged at an interval along the first direction, and a connecting structure connected between the two supporting portions, wherein one of the two supporting portions is fixedly connected to the first rotating shaft through the first connecting segment, another one of the two supporting portions is fixedly connected to the second rotating shaft through the second connecting segment, each of the first connecting segment and the second connecting segment is provided with a tapered sub-segment, a distance between the tapered sub-segment of the first connecting segment and the tapered sub-segment of the second connecting segment in the first direction gradually decreases along a direction away from the two supporting portions, and both the first connecting segment and the second connecting segment have elasticity.

4. The electric heating knife with a bracket according to claim 2, wherein the supporting frame comprises two supporting portions arranged at an interval along the first direction, the electric heating knife is provided with a hypothetical reference plane, the reference plane is perpendicular to the placement table and parallel to an extending direction of the blade, when the supporting frame is engaged with the first limiting portion, the rotation axis of the first rotating shaft has a first projection point on the reference plane, each of the two supporting portions has a second projection point on the reference plane, and an angle α is provided between a line connecting the first projection point with the second projection point and the extending direction of the blade, wherein the angle α satisfies: 30°˜90°.

5. The electric heating knife with a bracket according to claim 1, wherein the first limiting portion comprises a first limiting plate protruding from one of the two sidewalls, and the second limiting portion comprises a second limiting plate protruding from another one of the two sidewalls, an extending direction of the first limiting plate intersects with an extending direction of the second limiting plate at an intersecting point, and the intersecting point coincides with the rotation axis of the first rotating shaft.

6. The electric heating knife with a bracket according to claim 5, wherein the supporting frame comprises a first connecting segment, a second connecting segment, two supporting portions arranged at an interval along the first direction, and a connecting structure connected between the two supporting portions, a stop platform is further provided on each of the two sidewalls in a protruding manner, when the first connecting segment and the second connecting segment respectively abut against the first limiting plate corresponding thereto, the stop platform and the first limiting plate are respectively located at two sides of the supporting frame, and a dimension of the stop platform in the first direction is less than a dimension of the first connecting segment in the first direction, and is less than a dimension of the second connecting segment in the first direction.

7. The electric heating knife with a bracket according to claim 6, wherein the stop platform and the first limiting plate are arranged at an interval, and the interval therebetween constitutes a first limiting groove, the stop platform and the second limiting plate are arranged at an interval, and the interval therebetween constitutes a second limiting groove, an extending direction of a first edge of the stop platform facing the first limiting plate is consistent with the extending direction of the first limiting plate, and an extending direction of a second edge of the stop platform facing the second limiting plate is consistent with the extending direction of the second limiting plate.

8. The electric heating knife with a bracket according to claim 1, wherein the hand-held portion is provided with an adapting end and a supporting end, the adapting end is provided with two connecting arms that are opposite and disposed at an interval in the first direction, an end of the connecting portion facing away from the knife holder is disposed in the interval and is rotatably connected to the two connecting arms, and a rotation axis of the connecting portion is parallel to the first direction.

9. The electric heating knife with a bracket according to claim 8, wherein the supporting frame comprises a first connecting segment, a second connecting segment, two supporting portions arranged at an interval along the first direction, and a connecting structure connected between the two supporting portions, one of the two supporting portions is fixedly connected to the first rotating shaft through the first connecting segment, another one of the two supporting portions is fixedly connected to the second rotating shaft through the second connecting segment, each of the first connecting segment and the second connecting segment is provided with a supporting sub-segment, a distance between the supporting sub-segment of the first connecting segment and the supporting sub-segment of the second connecting segment are equal in the first direction, the two connecting arms are provided with two supporting outer wall surfaces disposed facing away from each other, the two supporting sub-segments are provided with two outer supporting surfaces facing away from each other, and a plane where one of the two outer supporting surfaces is located coincides with a plane where one of the two supporting outer wall surfaces is located.

10. The electric heating knife with a bracket according to claim 9, wherein each of the first connecting segment and the second connecting segment is provided with a tapered sub-segment, a distance between the tapered sub-segment of the first connecting segment and the tapered sub-segment of the second connecting segment in the first direction gradually decreases along a direction away from the two supporting portions to provide the first rotating shaft and the second rotating shaft with a force causing the first rotating shaft and the second rotating shaft to approach each other.

11. The electric heating knife with a bracket according to claim 8, wherein the supporting frame comprises two supporting portions facing away from the first rotating shaft and arranged at an interval in the first direction, the two supporting portions have a first dimension L1 in the first direction, a maximum dimension of the handle in the first direction is L2, and L1=(0.9˜1.5)×L2.

12. The electric heating knife with a bracket according to claim 11, wherein the maximum dimension L2 of the handle in the first direction is a distance between two supporting outer wall surfaces disposed facing away from each other of the two connecting arms, and L1=L2.

13. The electric heating knife with a bracket according to claim 11, wherein L1=1.4×L2.

14. The electric heating knife with a bracket according to claim 1, wherein the hand-held portion is provided with an adapting end and a supporting end, and the supporting end is provided with a hanging and connecting portion.

15. The electric heating knife with a bracket according to claim 14, wherein the hanging and connecting portion is any one of a hook, a hanging hole, or a hanging ring.

16. The electric heating knife with a bracket according to claim 1, wherein the bracket is made by bending a metal wire.

17. The electric heating knife with a bracket according to claim 16, wherein the metal wire is a steel wire or an iron wire.

18. The electric heating knife with a bracket according to claim 1, wherein the bracket has an integral structure.
